(19) United States
(12) Patent Application Publication
(10) Pub. No.: US 2010/0162905 A1
(43) Pub. Date: Jul. 1, 2010

(54) Fat eraser

(76) Inventors: Pat Y. Mah, Kowloon (HK); Alexander Joseph Kalogroulis, Coulsdon (GB); K. K. Tung, Kowloon (HK); Michael Ng, Adelaide (AU)

Correspondence Address: Harrington & Harrington, P.O. Box 91719, LONG BEACH, CA, 90809-1719, US

(21) Appl. No.: 12/318,000

(22) Filed: Dec. 30, 2008

(51) Int. Cl. A47J 43/00

(52) U.S. Cl. 99/495

(57) ABSTRACT

A “fat eraser” system provides a housing for supporting and possibly enclosing a low temperature heat absorbing material and having a thermally conductive area of material in a shallow conic shape which can be brought into contact with a volume of food to enable a low temperature solidification of fat onto the thermally conductive area of material. A combination storage stand and fat scraping body includes scraping blades having an upper contour which is complementary to the shallow conic shape of the thermally conductive area of material to provide a self-centering ability to cleanly scrape and remove and collect any solidified fat from the thermally conductive area of material by rotating the thermally conductive area of material about its conical center and against the combination storage stand and fat scraping body.

### FIELD OF THE INVENTION

The present invention relates to an improvements in the design and operation of a cooking implements which will enable removal of excess amounts of fat from a volume of prepared food, into which the fat is dispersed, by solidification and collection for conservation or disposal.

### BACKGROUND OF THE INVENTION

Clean, controlled removal of fats, greases, butter and other high solidification hydrocarbon material, hereinafter “fat” from prepared foods is desirable for a number of reasons. In some cases the fat is used to transport a flavoring element and was necessary at significant volume during the cooking process, and after cooking and distribution of the flavoring element is completed the volume of fat can be removed without changing the flavor of the food present. Where the fat physically separates from the volume of the food material so that it may be visually identified, techniques of removal have included insertion of wicking material such as cloth or paper towels, as well as a pour-off or skimming and drainage.

The purpose for fat removal may range from aesthetics in producing a prepared food without pools of visually separated fats, or foods from which fats may separate when served, to a need for restricting dietary fat intake. These wicking and pour-off methods are only able to be practiced where there is some pre-existing physical ability or occurrence of segregation of the fat in the prepared food. Where there is no identifiable physical separation, the introduction of a wicking towel might just as easily absorb water and other components of the prepared dish which were not to be removed. Without physical separation of fat in the prepared dish, no significant pour-off would be possible.

In some other cases, the desire to conserve the fat as an expensive element in food preparation, and to prevent its being wasted and to provide for its recovery for later use may also be present. The ability to conserve and recycle fat from one prepared food dish into another can be advantageous. Some of the conserving, recycling cases might involve serial batch processing of food where the fat recovered from a just completed batch of food can be transferred back to a batch of food just beginning its processing. In other cases, an amount of fat saved from preparation of one type of food might be preserved and recycled back into the preparation of the same food at a later date. In other cases the fat from the preparation of one food might be cross cycled into the preparation of another food either because of its flavor or simply because of a desire to conserve new fat which would otherwise be brought into the cooking process.

U.S. Pat. No. 4,024,057 which issued to Dorothy Joan McCoy on May 17, 1977 entitled “Portable, Cold Grease Remover” disclosed the use of a plate with heat fin row projections for increasing a lower surface area, and which could be used to support either a small sealed container of coolant or an accordion expanding reservoir of liquid. McCoy taught the bringing into contact of the lower heat finned plate onto contact with any grease which might be observed to float on the upper surface of a broth or soup, causing the fat to solidify and adhere to the undersurface of the plate. McCoy suggests that any solidified fat on the underside of the plate can be removed by scraping or heating. However, it is clear that both the device and the method of McCoy is problematic. Scraping the lower plate of McCoy must either involve a comb which matches the shape of the heat fin surface, or the fat will be left in rows between adjacent heat fins. McCoy also suggests re-heating the plate and draining the fat, but this involves another container, another heating step, and yet a further collection step. The plate would need to be dis-assembled, and placed in a container, the fat melted and then re-removed from the container into which it is collected. Its true that scraping during processing, which would leave fat adhered to the rows between the heat fins, could be tolerated during the fat collection operation, but this reduces the efficiency of the operation. It should be remembered that as the fat solidifies onto a metal surface, it represents an insulative presence to heat conduction with respect to the conductivity of a metal plate. Considering the fat as a thermal insulator, the ribbed plate of McCoy which is scraped using a simple edge device, and which leaves fat in the heat fins is then re-employed into the food dish, experiences a proportional reduction in its effective area available for adhesion of thermally solidifying fat.

Further, fat can be difficult to remove from an expanded surface. McCoy teaches the use of an expanded surface and a comb or complementary structure would have to remove fat from an expanded surface. This mechanism would produce significant force resistance. The result would be either a fixed comb requiring the user to exert significant upper body strength to scrape the heat fin surface. In the alternative, a hand held comb would have to be forced against a hand held plate and the scraping action would produce significant twisting stress between the hand held comb or complementary plate, and the collecting plate of McCoy. The hand held comb or complementary plate might be as likely to slip, and flip fat across the room, especially for users lacking upper body strength. Thus, cleaning of the McCoy plate would require a hand held comb or complementary plate in one hand, and the collection plate in the other hand, with both being positioned over a collection bowl. This system is simply not practical for instances in which small amounts of fat are to be collected, nor effective for instances where large amounts of fats are to be collected particularly by persons with limited upper body strength.

Another problem with McCoy is the inability for the plate to move into a volume of food and collect fat by solidification at different levels. Not all of the fat in a volume of food will rise to the top into a visually identifiable pool. A plate, such as the plate in McCoy, with its sealed container and ladle supported plate cannot practically be thrust into a volume of food for a number of reasons. First, pressing straight down would simply macerate and destroy the look and average size of the masses of food. Second, the skirt of McCoy will likely not withstand any lateral motion, and the expandable foil skirt would likely collapse. McCoy teaches collection of fat only from the top of broth or soup. The heat transfer surface is generally planar, with or without heat fins, an can only be placed atop the mass of food for which fat removal is desired.

As a practical matter, if the fat is not exactly at the surface, the McCoy device has no practical way to capture it. McCoy is faced with either providing a nearly infinitely thin layer of a food volume in hopes of observing and trying to capture fat, or it can only operate for clear broths based upon the overwhelming predominance of water and both the hydrophobic properties of the fat, and a light density which causes the fats to accumulate at the top.

For other foods, which are not clear broths or soups, and which may be hydrophobic enough to cause fat to attach and cling to the food material (most of which may be amino acids and proteins having varying degrees of hydrophobic and hydrophilic characteristics) in locations such that they cannot float to the top. A user preparing such foods may be under the mistaken impression that no recoverable or excess fat is present simply because no fat is seen collecting at the top.

Generally, the use of a device such as the McCoy device, only at the very top of soups or broths reduces the ability to provide extraction and some purification of fat that might exist throughout the volume of the foodstuff. Solidification of fat based upon a low temperature source has an ability to provide some purification. Where the user is looking for a pool of clear fat at the top of a volume of cooked foodstuff, the device of McCoy provides very little additional purification. As a result the disadvantages of the device of McCoy, or any device which uses a contact plate at the top of a volume of a food volume include complete avoidance of the ability to gather fat which has not already been clarified and pooled at the top of the food volume. This results in (1) an inability to probe the food volume in a manner which will move the food aside without macerating it, to test for fat that has not risen to the top, (2) the inability to compete with food particles for fat which is clinging to the food particles, (3) a general psychological pre-disposition to utilize a plate device to gather fat only when it is visible at the top, (4) a prejudice of assuming that no fat is present when none is seen, and (5) due to the relatively large plate and cold source container of McCoy which must be assembled and set up whenever fat is desired to be gathered, avoidance of fat collection will occur for all but the largest volumes of food.

What is therefore needed is a fat gathering system which is simple to set up, which can remove fat from a volume of food even where the fat is not visible and where it does not necessarily pool at the top of the volume of food. The fat gathering system should also be able to function as a fat probe to help alert users as to the presence and amount of fat in a volume of food without macerating it. The needed system should also facilitate separation of the fat from the implements of the system, in a controlled and orderly way, and which can be used by individuals without significant upper body strength.

### SUMMARY OF THE INVENTION

A “fat eraser” system utilizes a body having a forward shallow curved or conical surface which can range from curving with a flat area to completely curved and which is used to probe into a volume of food without macerating the food to collect the fat from that volume of food. In a first embodiment, a larger housing includes a space for loading with ice and water, or loaded with ice which then becomes a mixture of ice and water after some melting occurs. When the space is filled a conically or curved surface cap made of high thermal conducting material, such as aluminum encloses the volume filled with ice and water. When the fat removal device is oriented with the high thermal conducting material oriented downward, the water and ice are then in direct contact with a thermal conductive conic plate. The conic plate end of the housing is then inserted into the mass of food as fat begins to solidify on the outside of the conic conductive plate which caps the unit.

Sometimes referred to as a “fat eraser”, the elongate housing is moved through the food in a in and out and angled side to side motion to move the conic plate into and through the mass of food without macerating the food. Thus, the conic plate serves to move the food masses out of the way rather than smashing or crushing them. As the “fat eraser” is continued to be moved through the food, fat will begin to solidify and collect onto the conic or curved plate. The immediate advantage of this system is striking in that it allows a user to hold the “fat eraser” in one hand and move it along and through the food mass to move it about, in order to “probe” the food volume possibly while examining the thermally transmissive plate as much as is necessary to ascertain the fat content of the food mass. This enables the user, with a little experience and depending upon the temperature of the food mass, to instantly get an early determination of the amount of fat in the food volume. The main housing may be made of plastic or even a coated plastic so that it fits easily and comfortably into the hand of the user. The conically shaped cap which is to have contact with the food volume may be made of highly thermally conductive aluminum so that it can actively and quickly remove heat from any fat contacting the surface of the main housing.

A combination storage stand and fat scraping body includes a set of three interconnected blades each having an upper shape which is complementary to the conical shaped cap. The complementary shape provides a self-centering effect, so that the eraser stays securely within the combination storage stand and fat scraping body while solid fat is being removed, and provides a multi blade scraping action so that minimum time is spent before the fat eraser can be re-deployed into contact with the food volume. The combination storage stand and fat scraping body has a convenient grip so that the self-centering fat removal structure and stand can be easily manipulated by people with limited upper body strength. Further, because the blades of the combination storage stand and fat scraping body have pass through spaces, removing any solid fat which accumulates between the blades is relatively easy. This is done by simply pushing the solid fat through the spaces between the blades with the users gloved fingers or with a tool.

In the first embodiment the housing may be more elongated, while in a second embodiment, the housing still presents a curved gently conic but greater diameter cap, in essence a shallow cone. A corresponding combination storage stand and fat scraping body is provided with blades having an upper configuration matching the cone shape of the cap. The second embodiment is expected to provide a significant amount of fat removal from a shallow food volume or from instances where the fat is expected to exist at a depth of from the surface to a centimeter or two below the surface. The second embodiment may also preferably have an enhanced heat absorption body for quick action and heavy fat removal loading, such as a gel pack or solid carbon dioxide (it will be preferable to provide a vent hole where solid carbon dioxide, or dry ice, is used as a low temperature heat absorbing material).

### BRIEF DESCRIPTION OF THE DRAWINGS

The invention, its configuration, construction, and operation will be best further described in the following detailed description, taken in conjunction with the accompanying drawings in which:

FIG. 1 is a perspective exploded view of a first embodiment of the fat eraser and illustrating a main housing seen adjacent a cap preferably made of a material with high thermal conductivity, with the cap seen over a combination storage stand and fat scraping body;

FIG. 2 illustrates the fat eraser of FIG. 1 in an orientation where the cap is applied to the pot and where the combination storage stand and fat scraping body supports the main housing and cap pot in a rest or storage position;

FIG. 3 is a top view of the fat eraser resting on its combination storage stand and fat scraping body;

FIG. 4 is a sectional view taken along line 4-4 of FIG. 3 illustrating the main capped housing in storage position atop the combination storage stand and fat scraping body;

FIG. 5 side schematic view illustrating the fat eraser shown schematically within a container which includes a volume of food and illustrating that the food eraser can be brought vertically down into the food mass and moved from side to side, in a manner to gently push into the volume of food and push it about without macerating any pieces of food within the food volume, and illustrating contact for fat removal;

FIG. 6 is a bottom view consistent with but taken oppositely with respect to the view of FIG. 3 and showing the scraping action of fat removal upon the turning of the fat eraser within the combination storage stand and fat scraping body so that fat collects between the scraping blades;

FIG. 7 is a perspective exploded view of a second embodiment of the fat eraser and illustrating an upper saucer shaped housing to facilitate manual handling, and seen adjacent a lower cone shaped member preferably made of a material with high thermal conductivity, for fitting underneath the upper saucer shaped housing, and shown over a combination storage stand and fat scraping body;

FIG. 8 illustrates the fat eraser of FIG. 7 in an orientation where the upper saucer shaped housing to facilitate manual handling is seen attached to the lower cone shaped member and resting atop the combination storage stand and fat scraping body;

FIG. 9 is a top view of the fat eraser resting on its combination storage stand and fat scraping body;

FIG. 10 is a sectional view taken along line 10-10 of FIG. 9 illustrating the main capped housing in storage position atop the combination storage stand and fat scraping body; and

FIG. 11 is a bottom view consistent but opposite with respect to the view of FIG. 3 and showing the scraping action of fat removal upon the turning of the fat eraser within the combination storage stand and fat scraping body so that fat collects between the scraping blades.

### DETAILED DESCRIPTION OF THE PREFERRED EMBODIMENT

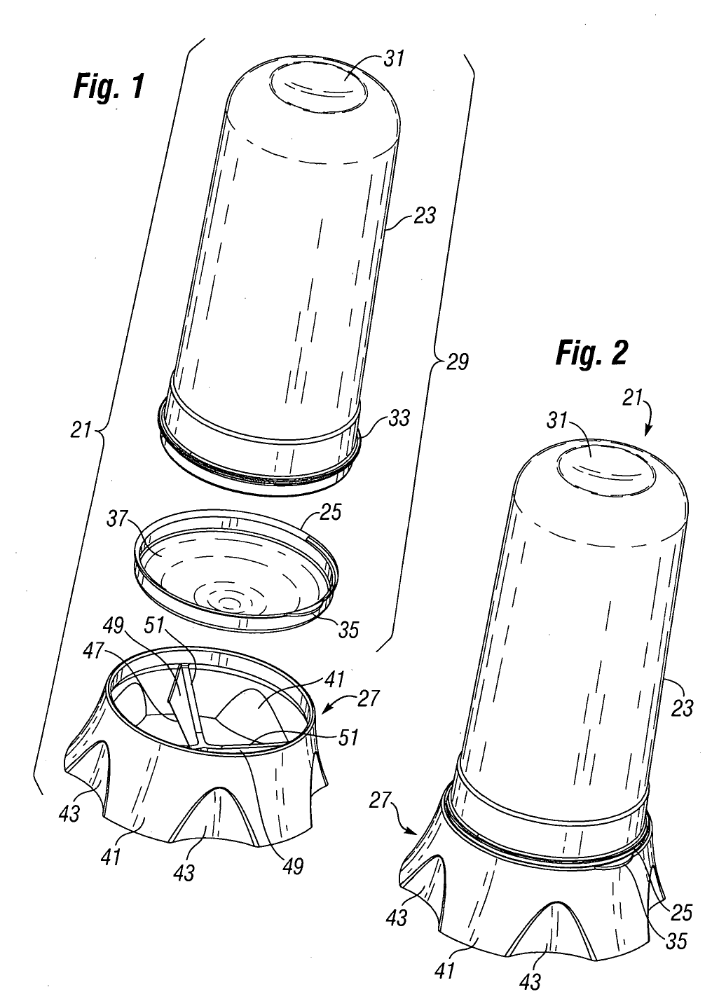

The description and operation of the fat eraser is best begun with reference to FIG. 1 which illustrates is an exploded view of a first embodiment of a fat eraser assembly 21 which includes a main housing 23, a cap 25 which can form an enclosure with respect to the main housing 23, and seen over a first embodiment of a combination storage stand and fat scraping body 27. The main housing 23 and the cap 25 forms the fat eraser 29 portion of the fat eraser assembly 21. The main housing 23 has a length which is of greater magnitude than its effective width to form a oblong shaped fat eraser 29.

The main housing 23 is shown as having a slight depression 31 at the upper end to assist in grasping and manipulating the fat eraser 29. Depression 31 also allows the fat eraser 29 to be stored in an inverted manner without the fat scraping body 27. In this manner the ice and water is in contact with the more thermally insulative plastic main housing 23, rather than the highly conductive cap 25. Storage in this manner conserves the heat absorbing capacity of the water and ice. A lip 33 is seen for stabilizing cap 25 and to provide a more readily recognizable indication to a user that the cap 25 is affixed to the main housing 23. The cap 25 is seen as having a lift tab 35 which extends outwardly of the lip 33 when the cap 25 is attached to the main housing 23 to help the user to remove the cap 25. The cap 25 can be seen a conic surface 37.

The combination storage stand and fat scraping body 27 has an exterior radial surface 41 surface which is somewhat flaring at the base, and interrupted by a series of finger depressions 43 to enable users to more securely grasp the combination storage stand and fat scraping body 27 when it is being used to scrape any solid fat which may have collected on the surface of the cap 25 facing the combination storage stand and fat scraping body 27.

At the inside of the combination storage stand and fat scraping body 27 a set of three scraping blades 47 are seen which extend to and joint at a radial center of the combination storage stand and fat scraping body 27. The blades 47 are seen as not extending downwardly to a lower extend of the bottom edge of the exterior radial surface 41 providing some clearance. The blades 47 each have a pair of oppositely disposed side surfaces 49, and a top surface 51. Top surface 51 can have a right angled relationship with respect to the side surface 49, or some other angled relationship.

In the orientation seen in FIG. 1, with the cap 25 securely attached to the main housing 23, and with some cold liquid being contained within the main housing 23, any fat on the exterior (underside of cap 25 as seen in FIG. 1) will be scraped by the blades 47 if the cap 25 is rotated against the blades 47 (as will be shown). The upper portion of the combination storage stand and fat scraping body 27 receives the cap 25 while allowing the cap 25 to turn and thus guides and stabilizes the cap 25 when cap 25 is turned to enable it to be scraped by the scraping blades 47.

Referring to FIG. 2 a collapsed view of the fat eraser assembly 21 seen in FIG. 1 is illustrated. The cap 25 is shown as applied to the main housing 23, and the combination storage stand and fat scraping body 27 is seen in a position of support with respect to the fat eraser 29, which is the same general position it would occupy were to be employed for scraping fat from the cap 25.

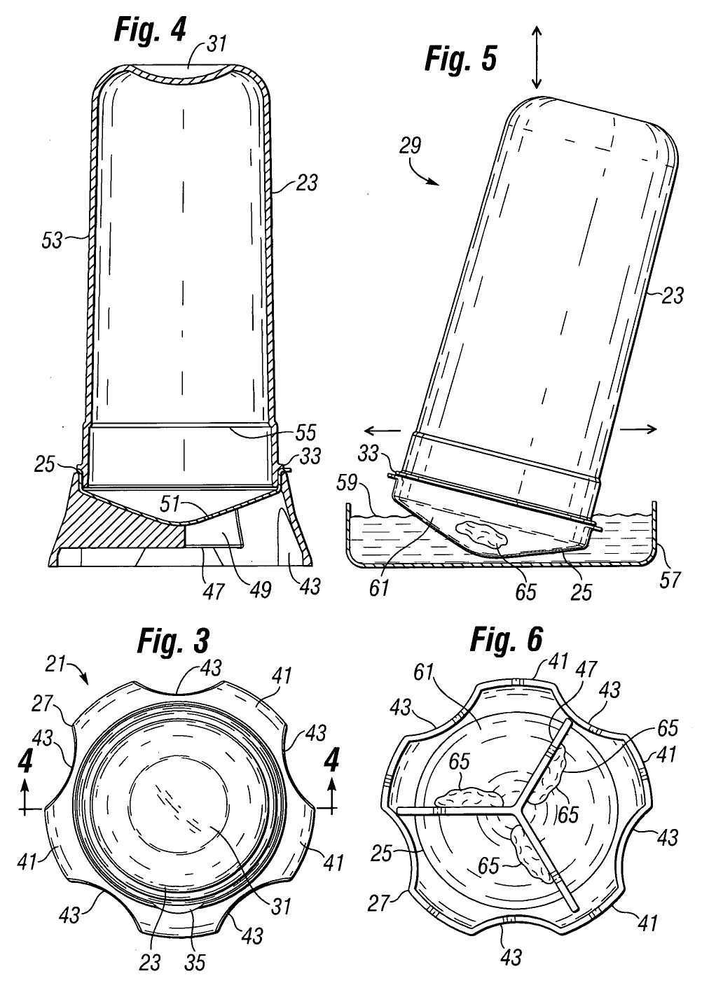

Referring to FIG. 3, a top view of the fat eraser 21 resting on its combination storage stand and fat scraping body 27, is shown. The lift tab 35 is seen as well as the fact that in this embodiment the finger depressions 43 are five in number. The slight depression 31 is also seen.

Referring to FIG. 4, a sectional view taken along line 4-4 of FIG. 3 illustrates the fat eraser 29 in a resting position atop the combination storage stand and fat scraping body 27. The centering interaction between the cap 25 and the complementary top surfaces 51 of the scraping blades 47 is seen. An internal volume 53 will contain the water and ice necessary to absorb heat through the conic area 37 of cap 25. Also visible is a transition surface 55 near the open end of the main housing 23.

Referring to FIG. 5, a side schematic view illustrating the fat eraser 29 is shown. Fat eraser 29 is shown schematically with respect to a container 57 containing a volume of food 59 which may contain fat. The fat eraser 29 is shown as being oriented at an angle and being moved laterally while the cap 25 is partially submerged in the volume of food 59. Notice that with a conical surface 61 of cap 25, that any food particles encountered while the fat eraser 29 is moved through the volume of food 59 will easily be urged gently to one side or the other due to the conical shape. As is shown in FIG. 6, movement laterally is possible as is forward movement at an angle. The conic shape of the conical surface 61 of cap 25 will facilitate pushing throught a local level of the volume of food 59 to move through it at a depth significantly below the level of the volume of food 59. The height of the cap 25 is not limited to the particular height shown in the figures. The height of the cap 25 may be greatly expanded to increase the probing nature of the action with regard to a volume of food 59. This would also result in a higher and deeper combination storage stand and fat scraping body 27. The proportions shown approximate a relative size which is believed to work well in most kitchen applications.

As the fat eraser 29 is moved through the volume of food 59 layers of fat 65 will begin to adhere to the conical surface 61 of cap 25. The solidified fat 65 will form somewhat of a thermal barrier, such that as more fat collected, a reduced flow of heat into the conical surface 61 of cap 25 will be experienced. Therefore, to increase the rate at which fat is collected, the conical surface 61 of cap 25 should be scraped to be free of fat as often as possible. Another factor to be considered is the temperature of the volume of food 59. A combination of high temperature and a thick layer of fat 65 might result in an equilibrium condition such that no further fat 65 is collected. So, depending upon the temperature of the volume of food 59 and the reduced temperature produced at the conical surface 61 of cap 25, as well as the thickness the layers of fat 65 adhering to the conical surface 61 of cap 25, the efficiency of fat collection will be affected.

For a warm volume of food 59, it has been found that a mixture of ice and water contained within the fat eraser 29 will be sufficient for fat 65 collection. An external temperature of the conical surface 61 of cap 25 of about eight degrees centigrade is achievable with water and ice. A lower temperature gel can be used (such as the type found commercially in plastic containers for use with a picnic cooler) to achieve a lower temperature. As a further alternative, a metal insert which includes the conical surface 61 could be brought to a super cold temperature and used as a non melting absorber of energy. Other low temperature sources can be used, such as dry ice or liquid gasses, so long as a gaseous exhaust port were provided on the fat eraser 29.

Referring to FIG. 6, a bottom view consistent with but taken oppositely with respect to the view of FIG. 3 illustrates the insertion of the fat eraser 29 back into the combination storage stand and fat scraping body 27 with the top surfaces 51 (not shown in FIG. 6) being pressed against the conical surface 61 of cap 25. Since the top surfaces 51 of the conical surface 61 of cap 25 are complementary to each other, a close very clean scraping of the fat 65 from conical surface 61 of cap 25 is obtained. All that the user need do is to turn the fat eraser 29, with its fat eraser assembly 21 main housing 23 and cap 25 turning together, against and relative to the top surfaces 51 of the scraping blades 47. This may be done while the combination storage stand and fat scraping body 27 is supported on a flat surface.

As can be seen in FIG. 6, rotation of the conical surface 61 of cap 25 against the scraping blades 47 causes fat 65 to collect on the side surface 49 opposite the direction of turning of the conical surface 61 of cap 25. The fat 65 can be continue to be collected until the inside of the combination storage stand and fat scraping body 27 completely fills (if combination storage stand and fat scraping body 27 is supported on a flat surface), or until the inverted bottom of the combination storage stand and fat scraping body 27 overflows (where the combination storage stand and fat scraping body 27 is inverted and turned atop the conical surface 61 of cap 25 like a valve).

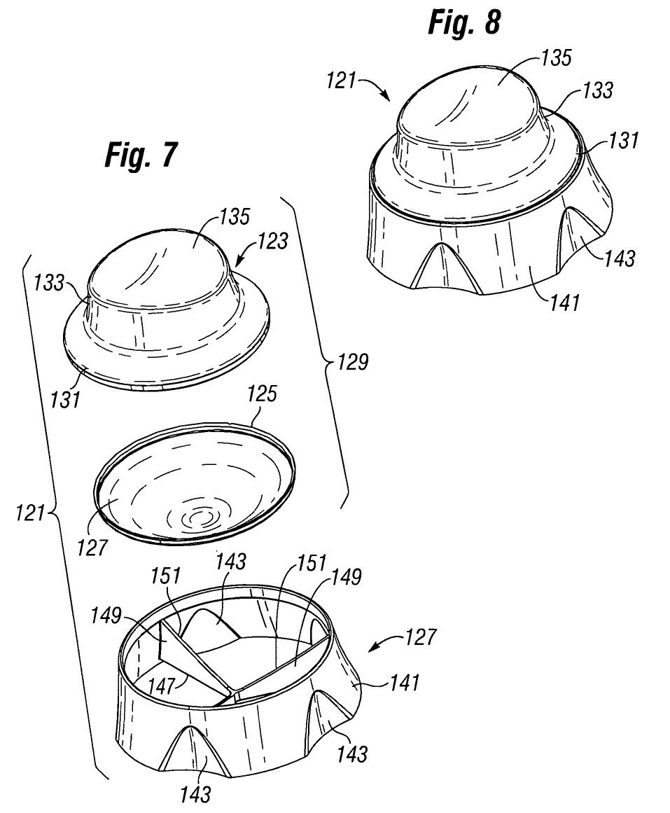

Referring to FIG. 7, a perspective exploded view of a second embodiment of the fat eraser system of the present invention is shown as a fat eraser system 121 which is shown in exploded view. The second embodiment of the fat eraser assembly 121 includes a main housing 123, a cap 125 made of a thermally high conductive material, and which can form an enclosure with respect to the main housing 123, and seen over a first embodiment of a second embodiment of a combination storage stand and fat scraping body 127. The main housing 123 and the cap 125 forms the fat eraser 129 portion of the fat eraser assembly 121. The main housing 123 has a length which is of lesser magnitude than its greatest effective width to form a flattened saucer shaped fat eraser 29.

The main housing 123 is shown as being saucer shaped having a radially expanded base 131. The radially expanded base 131 helps to provide a larger footprint for instances where fat is expected to be harvested from a container 57 having a larger area and in which the fat is not expected to be present in concentrations as great throughout a volume of food 59. Atop the radially expanded base 131 is a raised cylindrical structure 133. Raised cylindrical structure 133 can be grasped like a knob for easy control and manipulation. A top surface 135 of the raised cylindrical structure 133 may be saddle shaped or flat. It may be preferable for the top surface 135 of the raised cylindrical structure 133 to enable the fat eraser 129 to be inverted with the coolant not losing capacity by absorbing as much ambient heat through the cap 125.

The cap 125 has conical surface 127. The cap 125 may, like cap 25 be made of thin, thermally conductive metal. The combination storage stand and fat scraping body 127 has an exterior radial surface 141 surface which is somewhat flaring at the base, and interrupted by a series of finger depressions 143 to enable users to more securely grasp the combination storage stand and fat scraping body 127 when it is being used to scrape any solid fat which may have collected on the surface of the cap 125 facing the combination storage stand and fat scraping body 127.

At the inside of the combination storage stand and fat scraping body 127 a set of three scraping blades 147 are seen which extend to and joint at a radial center of the combination storage stand and fat scraping body 127. The blades 147 are longer because the effective diameter of the combination storage stand and fat scraping body 127 is greater than combination storage stand and fat scraping body 27. The blades 147 seen as not extending downwardly to a lower extend of the bottom edge of the exterior radial surface 141 providing some clearance. The blades 147 each have a pair of oppositely disposed side surfaces 149, and a top surface 151. Top surface 151 can have a right angled relationship with respect to the side surface 149, or some other angled relationship. Again, the upper portion of the combination storage stand and fat scraping body 127 receives the cap 125 while allowing the cap 125 to turn and thus guides and stabilizes the cap 125 when cap 125 is turned to enable it to be scraped by the scraping blades 147.

In the orientation seen in FIG. 1, with the cap 125 securely attached to the main housing 123, and with some cold liquid being contained within the main housing 23, any fat on the exterior (underside of cap 25 as seen in FIG. 1) will be scraped by the blades 147 if the cap 125 is rotated against the blades 147, and despite the greater area of the fat eraser 129, the additional volume within the raised cylindrical structure 133 will help to give an expanded volumetric capacity.

Referring to FIG. 8 a collapsed view of the fat eraser assembly 121 seen in FIG. 7 is illustrated. As before the cap 125 is shown as applied to the main housing 123, with the combination storage stand and fat scraping body 127 being seen in a position of support with respect to the fat eraser 129, which is the same general position it would occupy were to be employed for scraping fat from the cap 125.

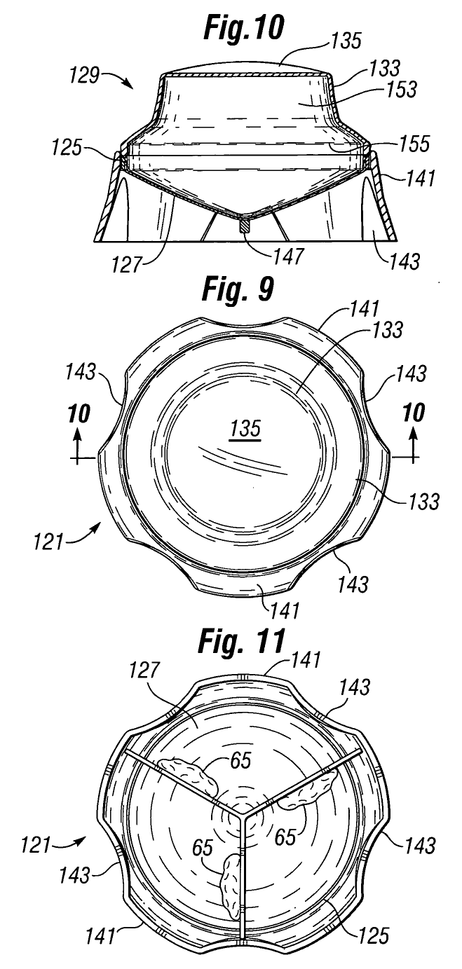

Referring to FIG. 9, a top view of the fat eraser 121 resting on its combination storage stand and fat scraping body 127, is shown. Although the combination storage stand and fat scraping body 127 is larger than the combination storage stand and fat scraping body 27, it is still not too large that it will not gain advantage from the finger depressions 143 which are also five in number.

Referring to FIG. 10, a sectional view taken along line 10-10 of FIG. 3 illustrates the fat eraser 129 in a resting position atop the combination storage stand and fat scraping body 127. The centering interaction between the cap 25 and the complementary top surfaces 151 of the scraping blades 147 is seen. Also visible is an internal volume 153 which will contain the ice and water, or other coolant mass. There is an internal transition 155 between the raised cylindrical structure 133 and the radially expanded base 131. A view looking directly into a section of one of the blades 147 is also seen.

Referring to FIG. 11, a bottom view consistent with but taken oppositely with respect to the view of FIG. 9 illustrates the insertion of the fat eraser 129 back into the combination storage stand and fat scraping body 127 with the top surfaces 151 (not shown in FIG. 11 being pressed against the conical surface 127 of cap 125. Since the top surfaces 151 and the conical surface 127 of cap 125 are complementary to each other, a close very clean scraping of the fat 65 from conical surface 127 of cap 125 is obtained. All that the user need do is to turn the fat eraser 129, with its fat eraser assembly 121 main housing 123 and cap 125 turning together, against and relative to the top surfaces 151 of the scraping blades 147. This may be done while the combination storage stand and fat scraping body 127 is supported on a flat surface or is hand held.

As can be seen in FIG. 11, rotation of the conical surface 127 of cap 125 against the scraping blades 147 causes fat 65 to collect on the side surface 149 opposite the direction of turning of the conical surface 127 of cap 125. The fat 65 can be continue to be collected in the same manner as was described for fat eraser 29.

While the present invention has been described in terms of a structure, device and process for extracting fat from a volume of prepared food using the transition of the fat from liquid to solid upon encountering a cooled surface, one skilled in the art will realize that the structure and techniques of the present invention can be applied to many structures and devices which are used in the kitchen, and particularly where temperature differences are used to preferentially capture components, either for conservation or elimination, by thermal solidification.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A fat eraser comprising:
a main housing having an internal volume for placing a heat absorptive material;
a thermally conductive cap fittable onto the main housing to enclose the internal volume and for immersion into a volume of food for enabling fat to solidify against an external conical surface of the thermally conductive cap; and
a combination storage stand and fat scraping body having a plurality of scraping blades having an upper surfaces which are complementary to the external conical surface of the thermally conductive cap to self-centeringly engage the plurality of scraping blades to enable an axial turning of the thermally conductive cap against the plurality of scraping blades to scrape any collected fat from the thermally conductive cap.

2. The fat eraser as recited in claim 1 wherein the main housing has a length greater than its effective diameter to form a pen shaped fat eraser.

3. The fat eraser as recited in claim 1 wherein the main housing has a length which is lesser magnitude than its effective width to form a saucer shaped fat eraser.

4. The fat eraser as recited in claim 1 wherein the combination storage stand and fat scraping body has a flaring base having a peripheral set of finger depressions to facilitate grasping of the combination storage stand and fat scraping body.

5. The fat eraser as recited in claim 1 wherein the combination storage stand and fat scraping body has a set of three of scraping blades each having one end attached to an inner peripery of the combination storage stand and fat scraping body and second end joining near a center of the combination storage stand and fat scraping body.
